(19) United States
(12) Patent Application Publication
(10) Pub. No.: US 2012/0052374 A1
(43) Pub. Date: Mar. 1, 2012

(54) NONAQUEOUS ELECTROLYTE AND NONAQUEOUS ELECTROLYTE BATTERY

(76) Inventors: Yuji UCHIDA, Fukushima (JP); Atsumichi Kawashima, Fukushima (JP)

(21) Appl. No.: 13/211,799

(22) Filed: Aug. 17, 2011

(30) Foreign Application Priority Data
Aug. 25, 2010 (JP) P2010-188762

(51) Int. Cl. H01M 10/056

(52) U.S. Cl. 429/188

(57) ABSTRACT

A nonaqueous electrolyte includes: an electrolyte salt, at least one of dimethyl carbonate and ethyl methyl carbonate, a chain carbonate ester represented by formula (I), and a polysiloxane compound represented by formula (II).

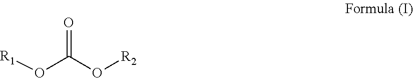

In the formula, R₁ represents CₙH₂ₙ₊₁, and n represents an integer of 13 to 20; and R₂ represents CₙH₂ₙ₊₁, and n represents an integer of 1 to 20.

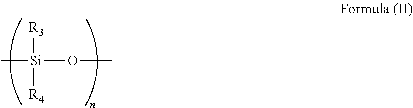

In the formula, R₃ and R₄ each represent hydrogen (H), an alkyl group having 1 to 50 carbon atoms, or a phenyl group; and a terminal of the polysiloxane compound preferably includes an alkyl group having a smaller number of carbon atoms and preferably excludes a proton, a functional group having a high reactivity with lithium (Li), and the like.

### BACKGROUND

The present technology relates to a nonaqueous electrolyte and a nonaqueous electrolyte battery. In more particular, the present technology relates to a nonaqueous electrolyte containing an organic solvent and an electrolyte salt, and a nonaqueous electrolyte battery using the same.

In recent years, portable electronic apparatuses, such as a video tape recorder, a cellular phone, and a notebook computer, have spread widely, and the reduction in size, reduction in weight, and increase in serviceable life of the apparatuses have been strongly requested. Concomitant with the above requests, a battery, in particular, a secondary battery which is light weight and which can obtain a high energy density, has been developed as a portable power supply of an electronic apparatus.

In particular, since an energy density higher than that of a related secondary battery, such as a lead battery or a nickel-cadmium battery, can be obtained by a secondary battery (so-called lithium-ion secondary battery) which uses occlusion and discharge of lithium (Li) for a charge/discharge reaction, the lithium-ion secondary battery has been practically used in many various fields. This lithium-ion secondary battery includes a nonaqueous electrolyte together with a positive electrode and a negative electrode.

In particular, for example, as disclosed in Japanese Patent No. 3482591, a laminate battery which uses an aluminum laminate film as an exterior member has a high energy density because of its light weight. In addition, in the laminate battery, as disclosed in Japanese Unexamined Patent Application Publication No. 2005-166448, since deformation of the laminate battery can be suppressed when a nonaqueous electrolyte is gelled by a polymer formed from a monomer, a laminate polymer battery has also been used widely.

However, when charge and discharge are repeatedly performed using dimethyl carbonate (DMC) or ethyl methyl carbonate (EMC) as a nonaqueous solvent component forming a nonaqueous electrolyte composition, these nonaqueous solvents may be disadvantageously decomposed to generate gases. Since the exterior member of the laminate battery is soft, if a nonaqueous solvent is decomposed, the battery may be deformed, and/or a discharge capacity retention rate at the time of repetition of charge and discharge may be decreased in some cases. Accordingly, as disclosed in Japanese Unexamined Patent Application Publication No. 2007-207485, it has been reported that a chain carbonate ester having a hydrocarbon group or a halogenated hydrocarbon group, each of which at least has 13 to 20 carbon atoms, is contained in a nonaqueous electrolyte composition.

### SUMMARY

However, when the chain carbonate ester is added to a nonaqueous electrolyte composition, the internal impedance of the battery is unfavorably increased, and hence a problem in that a discharge capacity at the time of large current discharge is decreased may arise.

The present technology was made in consideration of this problem, and it is desirable to provide a nonaqueous electrolyte secondary battery having a high discharge capacity retention rate at the time of repetition of charge and discharge and a large discharge capacity at the time of large current discharge.

According to an embodiment of the present technology, there is provided a nonaqueous electrolyte which includes an electrolyte salt, at least one of dimethyl carbonate and ethyl methyl carbonate, a chain carbonate ester represented by formula (I), and a polysiloxane compound represented by formula (II).

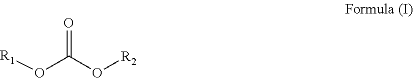

(In the formula, R₁ represents CₙH₂ₙ₊₁, and n represents an integer of 13 to 20. In addition, R₂ represents CₙH₂ₙ₊₁, and n represents an integer of 1 to 20.)

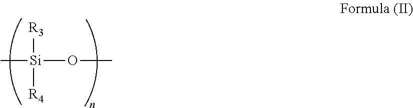

(In the formula, R₃ and R₄ each represent hydrogen (H), an alkyl group having 1 to 50 carbon atoms, or a phenyl group. In addition, a terminal of the polysiloxane compound preferably includes an alkyl group having a smaller number of carbon atoms and preferably excludes a proton, a functional group having a high reactivity with lithium (Li), and the like).

In addition, according to an embodiment of the present technology, there is provided a nonaqueous electrolyte battery which includes a positive electrode, a negative electrode, and a nonaqueous electrolyte, and the nonaqueous electrolyte includes an electrolyte salt, at least one of dimethyl carbonate and ethyl methyl carbonate, a chain carbonate ester represented by the formula (I), and a polysiloxane compound represented by the formula (II).

In addition, according to an embodiment of the present technology, there is provided a nonaqueous electrolyte battery which includes a positive electrode, a negative electrode, and a nonaqueous electrolyte containing an electrolyte salt and at least one of dimethyl carbonate and ethyl methyl carbonate, and the positive electrode is provided with, on at least a part of a surface thereof, a coating film derived from a chain carbonate ester represented by the formula (I) and a coating film derived from a polysiloxane compound represented by the formula (II).

According to an embodiment of the present technology, since the chain carbonate ester represented by the formula (I) and the polysiloxane compound represented by the formula (II) are contained in the nonaqueous electrolyte, the coating films derived therefrom are each formed on the positive electrode. It is believed that, in particular, the coating film formed by addition of the chain carbonate ester represented by the formula (I) has an effect of suppressing decomposition of the electrolyte on the surface of the positive electrode during a charge and discharge cycle. In addition, although the resistance of the surface of the electrode is increased by the film formation by the addition of the chain carbonate ester represented by the formula (I), it is believed that this resistance increase is suppressed by the coating film formed by the addition of the polysiloxane compound represented by the formula (II).

According to an embodiment of the present technology, by suppression of the decomposition of the nonaqueous electrolyte during a charge and discharge cycle, the increase in battery resistance is suppressed concomitant with the improvement in cycle characteristics, and hence large current discharge characteristics can also be maintained.

### BRIEF DESCRIPTION OF THE DRAWINGS

FIG. 1 is a cross-sectional view showing a structural example of a nonaqueous electrolyte battery according to an embodiment of the present technology;

FIG. 2 is a partially enlarged cross-sectional view of a wound electrode body shown in FIG. 1;

FIG. 3 is an exploded perspective view showing a structural example of a nonaqueous electrolyte battery according to an embodiment of the present technology;

FIG. 4 is a cross-sectional view of a wound electrode body shown in FIG. 3 taken along the line IV-IV;

FIG. 5 is a cross-sectional view showing another structural example of a nonaqueous electrolyte battery according to an embodiment of the present technology; and

FIG. 6 is a schematic view showing another structural example of a nonaqueous electrolyte battery according to an embodiment of the present technology.

### DETAILED DESCRIPTION OF EMBODIMENTS

Hereinafter, embodiments of the present technology will be described with reference to the drawings. Incidentally, description will be made in the following order.

1. First embodiment (example of a nonaqueous electrolyte containing a chain carbonate ester and a polysiloxane compound)
2. Second embodiment (example of using a cylindrical type nonaqueous electrolyte battery)
3. Third embodiment (example of using a laminate type nonaqueous electrolyte battery)
4. Fourth embodiment (example of using a laminate type nonaqueous electrolyte battery)
5. Fifth embodiment (example of using a square type nonaqueous electrolyte battery)
6. Sixth embodiment (example of a nonaqueous electrolyte battery using a laminate type electrode body)
7. Other embodiments

### 1. First Embodiment

A nonaqueous electrolyte according to the first embodiment of the present technology will be described. The nonaqueous electrolyte according to the first embodiment of the present technology is used, for example, for an electrochemical device, such as a battery. The nonaqueous electrolyte includes both a chain carbonate ester and a polysiloxane compound together with a common nonaqueous solvent and a common electrolyte salt.

### (1-1) Chain Carbonate Ester

The chain carbonate ester according to this embodiment of the present technology is represented by the following formula (I) and is contained as one nonaqueous solvent.

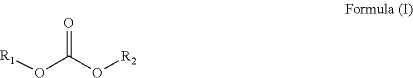

(In the formula, R₁ represents CₙH₂ₙ₊₁, and n represents an integer of 13 to 20. In addition, R₂ represents CₙH₂ₙ₊₁, and n represents an integer of 1 to 20.)

The carbonate ester of the formula (I) contained in the nonaqueous electrolyte is decomposed to form a coating film on a surface of a positive electrode. At the time of charge and discharge, the surface of the positive electrode is liable to be placed under an oxidizing environment. Accordingly, oxidation of the surface of the positive electrode is suppressed by a positive-electrode coating film formed from the carbonate ester of the formula (I). Accordingly, decomposition of the nonaqueous electrolyte at the interface of the positive electrode can be suppressed. It is believed that the carbonate ester of the formula (I) contributes to improvement of the battery characteristics, in particular, when a charge and discharge cycle progresses.

In addition, as the chain carbonate ester, a mixture containing materials having different numbers of carbon atoms, each of which satisfies the conditions of the formula (I), may be used.

As the carbonate ester of the formula (I), for example, ditetradecyl carbonate, ditridecyl carbonate, dieicosyl carbonate, and methyl tetradecyl carbonate are preferable.

The content of the chain carbonate ester of the formula (I) in the nonaqueous electrolyte is preferably in a range of 0.05 to 1.0 percent by mass. When the content of the chain carbonate ester of the formula (I) is too low, an addition effect thereof may not be fully obtained. In addition, since the chain carbonate ester of the formula (I) has a function of decreasing the battery characteristics at the time of large current discharge, if the content is excessively high, the battery characteristics at the time of large current discharge are unfavorably degraded.

### (1-2) Polysiloxane Compound

The polysiloxane compound according to this embodiment of the present technology is represented by the following formula (II).

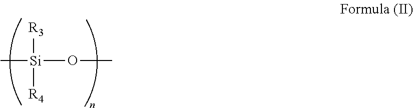

(In the formula, R₃ and R₄ each represent hydrogen (H), an alkyl groups having 1 to 50 carbon atoms, or a phenyl group. In addition, a terminal of the polysiloxane compound preferably includes an alkyl group having a small number of carbon atoms and preferably excludes a proton, a functional group having a high reactivity with lithium (Li), and the like.)

The polysiloxane compound of the formula (II) contained in the nonaqueous electrolyte is decomposed to forms a coating film on a surface of the positive electrode or on surfaces of the positive electrode and a negative electrode. It is believed that at this stage, since a decomposition potential of the polysiloxane of the formula (II) is close to that of the chain carbonate ester of the formula (I), the coating films are formed at the same time. In addition, the coating film formed by decomposition of the chain carbonate ester of the formula (I) has a high resistance, and on the other hand, the coating film formed by decomposition of the polysiloxane of the formula (II) has a low resistance. Accordingly, the resistance of a coating film which is formed when the above two materials are contained in an electrolyte is decreased lower than the resistance of the coating film formed only by the chain carbonate ester of the formula (I). Hence, when the polysiloxane of the formula (II) and the chain carbonate ester of the formula (I) are both present in the electrolyte, an increase in resistance caused by the addition of the chain carbonate ester of the formula (I) can be suppressed, and in addition, degradation of the battery characteristics at the time of large current discharge can be suppressed.

As the polysiloxane compound, a mixture formed of different materials, each of which satisfies the formula (II), may also be used.

As the polysiloxane compound of the formula (II), for example, a polydimethylsiloxane, a polydiethylsiloxane, a polymethylphenylsiloxane, and a polyethylphenylsiloxane may be preferable.

The content of the polysiloxane compound of the formula (II) in the nonaqueous electrolyte is preferably in a range of 0.05 to 1.0 percent by mass. When the content of the polysiloxane compound of the formula (II) is too low, an addition effect of the polysiloxane compound of the formula (II) may not be fully obtained. In addition, when the content of the polysiloxane compound of the formula (II) is excessively high, it is not preferable since the battery characteristics are degraded as the charge and discharge cycle progresses.

In addition, the chain carbonate ester represented by the formula (I) and the polysiloxane compound represented by the formula (II) are preferably mixed together at a mass ratio (chain carbonate ester/polysiloxane compound) in a range of 0.25 to 2.00. When the content of the chain carbonate ester is too high, the effect of suppressing degradation of the battery characteristics at the time of large current discharge is decreased. In addition, when the content of the polysiloxane compound is too high, the effect of suppressing degradation of the battery characteristics is decreased when the charge and discharge cycle progresses.

### (1-3) Composition of Nonaqueous Electrolyte Containing Chain Carbonate Ester and Polysiloxane Compound

### [Electrolyte Salt]

The electrolyte salt contains, for example, at least one type of light metal salt, such as a lithium salt. As this lithium salt, for example, Lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), or lithium bromide (LiBr) may be mentioned. Among those mentioned above, at least one of lithium hexafluorophosphate (LiPF₆), lithium tetrafluoroborate (LiBF₄), lithium perchlorate (LiClO₄), and lithium hexafluoroarsenate (LiAsF₆) is preferable, and lithium hexafluorophosphate (LiPF₆) is more preferable. The reason for this is that the resistance of the nonaqueous electrolyte is decreased. In particular, lithium tetrafluoroborate (LiBF₄) is preferably used together with lithium hexafluorophosphate (LiPF₆). The reason for this is that a significant effect can be obtained.

### [Nonaqueous Solvent]

As a nonaqueous solvent used together with the carbonate ester of the formula (I), for example, there may be mentioned ethylene carbonate (EC), propylene carbonate (PC), butylene carbonate (BC), dimethyl carbonate (DMC), diethyl carbonate (DEC), ethyl methyl carbonate (EMC), methyl propyl carbonate (MPC), γ-butyrolactone, 7-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyl oxazolidinone, N,N′-dimethylimidazolidinone, nitromethane, nitroethane, sulfolane, trimethyl phosphate, and dimethyl sulfoxide. The reason for this is that in electrochemical devices, such as a battery, including a nonaqueous electrolyte, excellent capacity, cycle characteristics, and storage characteristics can be obtained. These compounds may be used alone, or at least two of them may be used in combination.

Among those compounds, at least one of dimethyl carbonate (DMC) and ethyl methyl carbonate (EMC), each of which is a low viscosity solvent, is preferably used as a nonaqueous solvent. The reason for this is that when dimethyl carbonate and/or ethyl methyl carbonate is mixed in an electrolyte, the mobility of ions is improved, and hence the electrical conductivity of the electrolyte is improved.

In addition, as the nonaqueous solvent, a cyclic carbonate represented by the following formula (III) or formula (IV) may also be contained. In addition, at least two types of compounds selected from those represented by the formula (III) and formula (IV) may be used in combination.

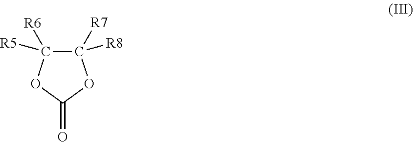

(In the formula, R₅ to R₈ each represent a hydrogen group, a halogen group, an alkyl group, or an alkyl halide group, and at least one of them is a halogen group or an alkyl halide group.)

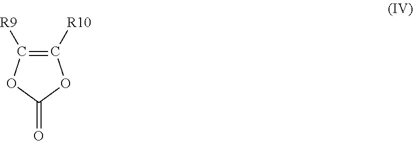

(In the formula, R₉ and R₁₀ each represent a hydrogen group or an alkyl group.)

As the cyclic carbonate ester containing a halogen group shown in the formula (III), for example, there may be mentioned 4-fluoro-1,3-dioxolane-2-one, 4-chloro-1,3-dioxolane-2-one, 4,5-difluoro-1,3-dioxolane-2-one, tetrafluoro-1,3-dioxolane-2-one, 4-chloro-5-fluoro-1,3-dioxolane-2-one, 4,5-dichloro-1,3-dioxolane-2-one, tetrachloro-1,3-dioxolane-2-one, 4,5-bis(trifluoromethyl)-1,3-dioxolane-2-one, 4-trifluoromethyl-1,3-dioxolane-2-one, 4,5-difluoro-4,5-dimethyl-1,3-dioxolane-2-one, 4,4-difluoro-5-methyl-1,3-dioxolane-2-one, 4-ethyl-5,5-difluoro-1,3-dioxolane-2-one, 4-fluoro-5-trifluoromethyl-1,3-dioxolane-2-one, 4-methyl-5-trifluoromethyl-1,3-dioxolane-2-one, 4-fluoro-4,5-dimethyl-1,3-dioxolane-2-one, 5-(1,1-difluoroethyl)-4,4-difluoro-1,3-dioxolane-2-one, 4,5-dichloro-4,5-dimethyl-1,3-dioxolane-2-one, 4-ethyl-5-fluoro-1,3-dioxolane-2-one, 4-ethyl-4,5-difluoro-1,3-dioxolane-2-one, 4-ethyl-4,5,5-trifluoro-1,3-dioxolane-2-one, and 4-fluoro-4-methyl-1,3-dioxolane 2-one. These compounds may be used alone, or at least two types thereof may be used in combination. In particular, 4-fluoro-1,3-dioxolane-2-one or 4,5-difluoro-1,3-dioxolane-2-one is preferable. The reasons for this are that a significant effect can be obtained thereby and the above compounds are easily commercially available.

As the cyclic carbonate having an unsaturated bond shown in the formula (IV), for example, there may be mentioned vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, or 4-trifluoromethyl-1,3-dioxol-2-one. These compounds may be used alone, or at least two types thereof may be used in combination. In particular, vinylene carbonate is preferable. The reasons for this are that a significant effect can be obtained thereby and the above compound is easily commercially available.

### [Polymer Compound]

In this embodiment of the present technology, the nonaqueous electrolyte formed of a mixture of a nonaqueous solvent and an electrolyte salt may also contain a support member containing a polymer compound to form a so-called gel.

Any material which is gelled by absorbing a solvent may be used as the polymer compound, and for example, there may be mentioned a fluorinated polymer compound, such as a poly(vinylidene fluoride) or a copolymer of vinylidene fluoride and hexafluoropropylene; an ether polymer compound, such as a poly(ethylene oxide) or a cross-linked compound containing the same; and a polymer compound containing a polyacrylonitrile, a poly(propylene oxide), or a poly(methyl methacrylate) as a repeating unit. The polymer compounds mentioned above may be used alone, or at least two types thereof may be used in combination.

In particular, in view of oxidation reduction stability, a fluorinated polymer compound is preferable, and a copolymer containing vinylidene fluoride and hexafluoropropylene as a component is particularly preferable. Furthermore, this copolymer may also contain as a component a monoester of an unsaturated dibasic acid, such as monomethyl maleate, a cyclic carbonate ester of an unsaturated compound, such as a vinylene carbonate or a halogenated ethylene including chlorotrifluoroethylene, or an epoxy group-containing acrylic vinyl monomer. The reason for this is that more excellent characteristics can be obtained.

A formation method of a gel electrolyte layer will be described later.

### <Effect>

According to the first embodiment of the present technology, the chain carbonate ester represented by the formula (I) and the polysiloxane compound represented by the formula (II) are contained in the nonaqueous electrolyte. By addition of the chain carbonate ester represented by the formula (I), when the charge and discharge cycle progresses, the reaction between the electrode and the nonaqueous electrolyte is suppressed, the amounts of gases generated thereby are reduced, and the degradation of the battery characteristics is suppressed. In addition, with the addition of the chain carbonate ester represented by the formula (I), the resistance of the surface of the electrode is increased, and the large current discharge characteristics are degraded; however, since the increase in electrode surface resistance is suppressed when the polysiloxane compound of the formula (II) simultaneously forms a coating film on the positive electrode, the degradation of the characteristics at the time of the large current discharge caused by the addition of the chain carbonate ester represented by the formula (I) can be prevented.

### 2. Second Embodiment

A nonaqueous electrolyte battery according to the second embodiment of the present technology will be described. The nonaqueous electrolyte battery according to the second embodiment is a cylindrical type nonaqueous electrolyte battery.

### (2-1) Structure of Nonaqueous Electrolyte Battery

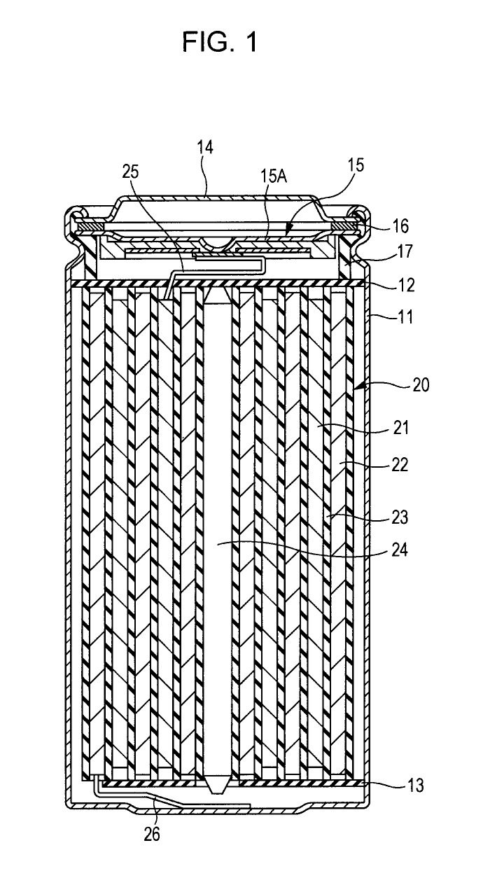

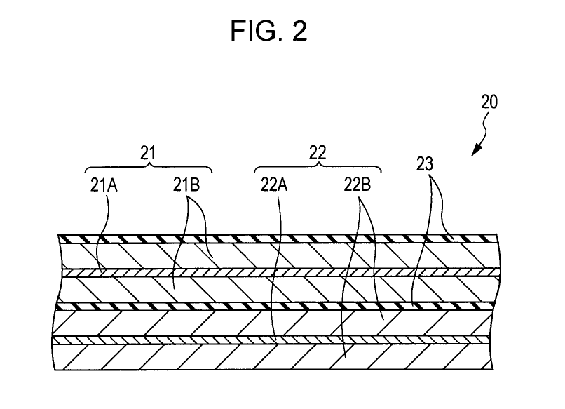

FIG. 1 is a cross-sectional view of the nonaqueous electrolyte battery according to the second embodiment of the present technology. FIG. 2 is a partially enlarged cross-sectional view of a wound electrode body 20 shown in FIG. 1. This nonaqueous electrolyte battery is a lithium-ion secondary battery in which, for example, the capacity of a negative electrode is represented based on occlusion and discharge of lithium which is an electrode reaction material.

### [Entire Structure of Nonaqueous Electrolyte Battery]

In this nonaqueous electrolyte battery, a pair of electrical insulating plates 12 and 13 and the wound electrode body 20 in which a positive electrode 21 and a negative electrode 22 are laminated and wound with separators 23 provided therebetween are primarily received in an approximately hollow cylindrical battery can 11. The battery structure using this cylindrical battery can 11 is called a cylindrical type.

The battery can 11 is formed, for example, of iron (Fe) plated with nickel (Ni), one end portion thereof is closed, and the other end portion is opened. Inside the battery can 11, the two electrical insulating plates 12 and 13 are arranged perpendicularly to a winding peripheral surface so as to sandwich the wound electrode body 20.

A battery lid 14, a safety valve mechanism 15, and a positive temperature coefficient element (PTC element) 16, the latter two being provided inside this battery lid 14, are fixed to the open end portion of the battery can 11 by caulking with a gasket 17 provided therebetween, and the inside of the battery can 11 is sealed.

The battery lid 14 is formed, for example, of a material similar to that of the battery can 11. The safety valve mechanism 15 is electrically connected to the battery lid 14 through the PTC element 16, and when the internal pressure of the battery is increased to a predetermined level or more, for example, by an internal short circuit or heating from the outside, a disc plate 15A is reversed so as to electrically disconnect the battery lid 14 from the wound electrode body 20.

The PTC element 16 is an element which when the temperature is increased, restricts an electric current by an increase in resistance and prevents abnormal heat generation caused by a large current. The gasket 17 is formed, for example, of an insulating material, and asphalt is applied to the surface thereof.

For example, a center pin 24 is inserted in the center of the wound electrode body 20. A positive electrode lead 25 formed, for example, of aluminum (Al) is connected to the positive electrode 21 of the wound electrode body 20, and a negative electrode lead 26 formed, for example, of nickel (Ni) is connected to the negative electrode 22. By being welded to the safety valve mechanism 15, the positive electrode lead 25 is electrically connected to the battery lid 14, and the negative electrode lead 26 is welded to the battery can 11 and is electrically connected thereto.

### [Positive Electrode]

The positive electrode 21 has the structure in which for example, two positive electrode active material layers 21B are provided on a pair of surfaces of a positive electrode collector 21A. However, the positive electrode active material layer 21B may be provided only on one surface of the positive electrode collector 21A. The coating film derived from the chain carbonate ester represented by the formula (I) and the coating film derived from the polysiloxane compound represented by the formula (II) are formed on each surface of the positive electrode. In addition, it is believed that the coating film derived from the chain carbonate ester and the coating film derived from the polysiloxane compound are simultaneously formed.

The positive electrode collector 21A is formed, for example, of a metal material, such as aluminum, nickel, or stainless steel.

As a positive electrode active material, the positive electrode active material layer 21B contains at least one type of positive electrode material capable of occluding and discharging lithium and may also contain other materials, such as a binder and a conducting agent, if necessary.

As the positive electrode material capable of occluding and discharging lithium, for example, a lithium-containing compound is preferable. The reason for this is that a high energy density can be obtained. As this lithium-containing compound, for example, there may be mentioned a composite oxide containing lithium and a transition metal element and a phosphoric acid compound containing lithium and a transition metal element. In particular, a compound containing at least one type selected from the group consisting of cobalt, nickel, manganese, and iron as a transition metal element is preferable. The reason for this is that a higher voltage can be obtained.

As the composite oxide containing lithium and a transition metal element, for example, there may be mentioned a lithium cobalt composite oxide (LixCoO₂), a lithium nickel composite oxide (LiₓNiO₂), a lithium nickel cobalt composite oxide (LiₓNi_{1-z}Co_{z}O₂ (z<1)), a lithium nickel cobalt manganese composite oxide (LiₓNi_{(1-v-w)}CoᵥMn_{w}O₂ (v+w<1)), or a composite oxide having a spinel type structure, such as a lithium manganese composite oxide (LiMn₂O₄) or a lithium manganese nickel composite oxide (LiMn₂₋ₜNiₜO₄ (t<2)). In particular, the composite oxide containing cobalt is preferable. The reason for this is that excellent cycle characteristics can be obtained as well as a high capacity. In addition, as the phosphoric acid compound containing lithium and a transition metal element, for example, a lithium iron phosphoric acid compound (LiFePO₄) or a lithium iron manganese phosphoric acid compound (LiFe₁₋ᵤMnᵤPO₄ (u<1)) may be mentioned.

Furthermore, in order to obtain more excellent electrode packing characteristics and cycle characteristics, composite particles may be used in which surfaces of core particles formed of one of the above lithium-containing compounds are covered with particles formed of one of the other lithium-containing compounds.

In addition, as the positive electrode material capable of occluding and discharging lithium, for example, an oxide, such as titanium oxide, vanadium oxide, or manganese dioxide; a sulfide, such as titanium disulfide or molybdenum sulfide; a chalcogen compound, such as niobium selenide; and a conductive polymer, such as sulfur, a polyaniline, or a polythiophene, may also be mentioned. Of course, as the positive electrode material capable of occluding and discharging lithium, materials other than those mentioned above may also be used. In addition, at least two of the above positive electrode materials may be arbitrarily used in combination.

### [Negative Electrode]

The negative electrode 22 has the structure in which for example, two negative electrode active material layers 22B are provided on a pair of surfaces of a negative electrode collector 22A. However, the negative electrode active material layer 22B may be provided only on one surface of the negative electrode collector 22A. The coating film derived from the polysiloxane compound of the formula (II) may be formed on each surface of the negative electrode.

The negative electrode collector 22A is formed, for example, of a metal material, such as copper, nickel, or stainless steel.

The negative electrode active material layer 22B contains as a negative electrode active material, at least one type of negative electrode material capable of occluding and discharging lithium and may also contain other materials, such as a binder and a conducting agent, if necessary. At this stage, a chargeable capacity of the negative electrode material capable of occluding and discharging lithium is preferably larger than the discharge capacity of the positive electrode. In addition, the details of the binder and the conducting agent are similar to those of the positive electrode.

As the negative electrode material capable of occluding and discharging lithium, for example, a carbon material may be mentioned. As this carbon material, for example, graphitizable carbon, non-graphitizable carbon having a (002) spacing of 0.37 nm or more, or graphite having a (002) spacing of 0.34 nm or less may be mentioned. In more particular, for example, there may be mentioned pyrolytic carbons, cokes, glassy carbon fibers, baked organic polymer compounds, activated carbons, or carbon blacks. Among these compounds, the cokes include pitch coke, needle coke, and petroleum coke. The baked organic polymer compounds include a carbonized substance obtained by baking a phenol resin, a furan resin, or the like at a suitable temperature. Since the change in crystalline structure of the carbon material caused by occlusion and discharge of lithium is small, excellent cycle characteristics can be preferably obtained together with a high energy density, and furthermore, since functioning as a conducting agent, the carbon material is preferable. In addition, as the shape of the carbon material, fibers, spheres, particles, and scales may be arbitrarily selected.

Besides the above carbon materials, as the negative electrode material capable of occluding and discharging lithium, for example, a material capable of occluding and discharging lithium and also containing at least one of a metal element and a semi-metal element as a constituent element may be mentioned. The reason for this is that a high energy density can be obtained. As the negative electrode material described above, a single substance, an alloy, or a compound of a metal element or a semi-metal element may be used, and for example, a material at least partially having at least one phase thereof may also be used. In addition, the “alloy” in this embodiment of the present technology includes, besides a substance composed of at least two metal elements, a substance composed of at least one type of metal element and at least one type of semi-metal element. The “alloy” may also contain a nonmetal element. As this texture, for example, there may be mentioned a solid solution, an eutectic (eutectic mixture), an intermetallic compound, or a substance in which at least two thereof coexist.

As the metal element or the semi-metal element mentioned above, for example, a metal element or a semi-metal element, each of which can form an alloy with lithium, may be mentioned. In particular, for example, there may be mentioned magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), or platinum (Pt). In particular, at least one of silicon and tin is preferable, and silicon is more preferable. The reason for this is that since a power of occluding and discharging lithium is high, a high energy density can be obtained.

As the negative electrode material containing at least one of silicon and tin, for example, a single substance, an alloy, and a compound of silicon; a single substance, an alloy, and a compound of tin; and a material at least partially having at least one phase thereof may be mentioned.

As the alloy of silicon, for example, there may be mentioned an alloy containing, as a second constituent element other than silicon, at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). As the alloy of tin, for example, there may be mentioned an alloy containing, as a second constituent element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

As the compound of tin or the compound of silicon, for example, a compound containing oxygen (O) or carbon (C) may be mentioned, and besides tin (Sn) or silicon (Si), the above second constituent element may also be contained.

In particular, as the negative electrode material containing at least one of silicon (Si) and tin (Sn), for example, a material containing tin (Sn) as a first constituent element and a second and a third constituent element besides tin (Sn) is preferable. Of course, this negative electrode material may also be used together with the negative electrode material described above. The second constituent element is at least one selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon (Si). The third constituent element is at least one selected from the group consisting of boron (B), carbon (C), aluminum (Al), and phosphorus (P). The reason for this is that when the second element and the third element are contained, the cycle characteristics are improved.

In particular, a CoSnC-containing material is preferable in which tin (Sn), cobalt (Co), and carbon (C) are contained as constituent elements, the content of carbon (C) is in a range of 9.9 to 29.7 percent by mass, and the content of cobalt (Co) to the total of tin (Sn) and cobalt (Co) (Co/(Sn+Co)) is in a range of 30 to 70 percent by mass. The reason for this is that in the composition range described above, excellent cycle characteristics can be obtained together with a high energy density.

This SnCoC-containing material may further contain other constituent elements, if necessary. As the other constituent elements, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), or bismuth (Bi) is preferable, and at least two of these elements may also be contained. The reason for this is that the capacitance characteristics or the cycle characteristics are further improved.

In addition, the SnCoC-containing material has a phase containing tin (Sn), cobalt (Co), and carbon (C), and this phase preferably has a low crystalline or an amorphous structure. Furthermore, in the SnCoC-containing material, carbon, which is a constituent element, is preferably at least partially bonded to a metal element or a semi-metal element, which is the other constituent element. The reason for this is that although it is believed that degradation of the cycle characteristics is caused by condensation or crystallization of tin (Sn) or the like, when carbon is bonded to the other element, the condensation or the crystallization is suppressed.

As a measurement method for investigating the bonding state of an element, for example, an X-ray photoelectron spectroscopy (XPS) method may be mentioned. In this XPS method, in an apparatus in which energy calibration is performed so that the peak of the 4f orbit (Au4f) of a gold atom is obtained at 84.0 eV, the peak of the is orbit (C1s) of carbon appears at 284.5 eV in the case of graphite. In addition, in the case of surface-contaminating carbon, the peak will appear at 284.8 eV. On the other hand, when the charge density of a carbon element is increased, for example, when carbon is bonded to a metal element or a semi-metal element, the peak of the C1s appears in a region lower than 284.5 eV. That is, when the peak of a C1s hybrid wave obtained from the SnCoC-containing material appears in a region lower than 284.5 eV, the carbon (C) contained in the SnCoC-containing material is at least partially bonded to a metal element or a semi-metal element, which is another constituent element.

In XPS, for example, the C1s peak is used for calibration of an energy axis of spectrum. In general, since surface-contaminating carbon is present on the surface, the C1s peak of the surface-contaminating carbon is regarded to appear at 284.8 eV, and this peak is used as an energy reference. In XPS, since the C1s peak waveform is obtained as a waveform which contains both the peak of the surface-contaminating carbon and the peak of the carbon in the CoSnC-containing material, the peak of the surface-contaminating carbon and the peak of the carbon in the CoSnC-containing material are separated from each other, for example, by an analysis conducted using a commercially available software. In the waveform analysis, the position of a main peak present on a minimum binding energy side is used as an energy reference (284.8 eV).

In addition, as the negative electrode material capable of occluding and discharging lithium, for example, a metal oxide or a polymer compound capable of occluding and discharging lithium may also be mentioned. As the metal oxide, for example, iron oxide, ruthenium oxide, or molybdenum oxide may be mentioned, and as the polymer compound, for example, a polyacetylene, a polyaniline, or a polypyrrole may be mentioned.

In addition, as the negative electrode material capable of occluding and discharging lithium, materials other than those mentioned above may also be used. Furthermore, at least two of the above negative electrode materials may be used in arbitrary combination.

The negative electrode active material layer 22B may be formed, for example, by any of a gas phase method, a liquid phase method, a spraying method, a baking method, and a coating method, and these methods may be used in combination. When the negative electrode active material layer 22B is formed using a gas phase method, a liquid phase method, a spraying method, a baking methods, or at least two of these methods, the negative electrode active material layer 22B and the negative electrode collector 22A are preferably alloyed at least a part of the interface therebetween. In particular, it is preferable that at the interface, the constituent element of the negative electrode collector 22A diffuse to the negative electrode active material layer 22B, the constituent element of the negative electrode active material layer 22B diffuse to the negative electrode collector 22A, or those constituent elements thereof diffuse to each other. The reasons for this are that destruction caused by expansion and contraction of the negative electrode active material layer 22B caused by charge and discharge can be suppressed, and in addition, that the electron conductivity between the negative electrode active material layer 22B and the negative electrode collector 22A can be improved.

As the gas phase method, for example, there may be mentioned a physical deposition method or a chemical deposition method, and in particular, for example, a vacuum deposition method, a sputtering method, an ion plating method, a laser ablation method, a thermal chemical vapor deposition (CVD) method, or a plasma enhanced CVD method may be mentioned. As the liquid phase method, for example, a common method, such as an electroplating or an electroless plating method, may be used. As the baking method, for example, a method may be mentioned in which after a particulate negative electrode active material mixed with a binder or the like is dispersed in a solvent, this solution thus prepared is applied and is then heat-treated at a temperature higher than the melting point of the binder. As the baking method, a common method may be used, and for example, an atmosphere baking method, a reaction baking method, or a hot press baking method may be mentioned.

### [Separator]

The separator 23 allows lithium ions to pass therethrough while isolating the positive electrode 21 from the negative electrode 22 and preventing short circuit caused by the contact between the two electrodes. This separator 23 is formed, for example, of a porous membrane of a synthetic resin, such as a polytetrafluoroethylene, a polypropylene, or a polyethylene, or a porous membrane of a ceramic and may be formed of a laminate of at least two of the above porous membranes. This separator 23 is impregnated with the above nonaqueous electrolyte according to the first embodiment.

### (2-2) Method for Manufacturing Nonaqueous Electrolyte Battery

The nonaqueous electrolyte battery described above can be manufactured as described below.

### [Manufacture of Positive Electrode]

First, the positive electrode 21 is formed. For example, a positive electrode mixture is formed by mixing a positive electrode material, a binder, and a conducting agent and is then dispersed in an organic solvent, so that a positive electrode mixture slurry in the form of paste is formed. Subsequently, by using a doctor blade or a bar coater, the positive electrode mixture slurry is uniformly applied to two surfaces of the positive electrode collector 21A and is then dried. Finally, the coating films thus prepared are compression-molded by a roll press machine or the like while heating is performed, if necessary, so that the positive electrode active material layers 21B are formed. In this case, the compression molding may be repeatedly performed a plurality of times.

### [Manufacture of Negative Electrode]

Next, the negative electrode 22 is formed. For example, a negative electrode mixture is formed by mixing a negative electrode material, a binder, and a conducting agent and is then dispersed in an organic solvent, so that a negative electrode mixture slurry in the form of paste is formed. Subsequently, by using a doctor blade or a bar coater, the negative electrode mixture slurry is uniformly applied to two surfaces of the negative electrode collector 22A and is then dried. Finally, the coating films are compression-molded by a roll press machine or the like while heating is performed, if necessary, so that the negative electrode active material layers 22B are formed.

### [Assembly of Nonaqueous Electrolyte Battery]

Next, the positive electrode lead 25 is fitted to the positive electrode collector 21A by welding or the like, and the negative electrode lead 26 is fitted to the negative electrode collector 22A by welding or the like. Then, the positive electrode 21 and the negative electrode 22 are wound with the separators 23 provided therebetween, and a front portion of the positive electrode lead 25 is welded to the safety valve mechanism 15. In addition, a front portion of the negative electrode lead 26 is welded to the battery can 11, and the positive electrode 21 and the negative electrode 22 which are wound as described above are sandwiched between the electric insulating plates 12 and 13 and are then received in the battery can 11. After the positive electrode 21 and the negative electrode 22 are received in the battery can 11, the nonaqueous electrolyte according to the first embodiment is charged in the battery can 11 so that the separators 23 are impregnated with the nonaqueous electrolyte. Subsequently, the battery lid 14, the safety valve mechanism 15, and the PTC element 16 are fixed to the open end portion of the battery can 11 by caulking with the gasket 17 provided therebetween. Accordingly, the nonaqueous electrolyte battery shown in FIGS. 1 and 2 is formed.

In the nonaqueous electrolyte battery described above, since the chain carbonate ester represented by the formula (I) contained in the nonaqueous electrolyte is decomposed at the first charge to form a coating film on the surface of the positive electrode, the reaction between the electrode and the nonaqueous electrolyte is suppressed, and the degradation of the battery characteristics caused by the reaction is suppressed. The reason for this is believed that by addition of the chain carbonate ester, the effect of suppressing degradation of the battery characteristics which occurs when the charge and discharge cycle progresses can be obtained.

In addition, the polysiloxane compound of the formula (II) is decomposed, and the coating film is formed primarily on the surface of the positive electrode. By the polysiloxane compound of the formula (II) contained in the nonaqueous electrolyte, the increase in electrode surface resistance caused by decomposition of the chain carbonate ester represented by the formula (I) is suppressed, and hence the degradation of the characteristics at the time of large current discharge caused by the addition of the chain carbonate ester represented by the formula (I) can be prevented.

### <Effect>

According to the second embodiment of the present technology, the nonaqueous electrolyte battery containing the chain carbonate ester represented by the formula (I) and the polysiloxane compound represented by the formula (I) in the nonaqueous electrolyte is used. Accordingly, excellent charge-discharge cycle characteristics and large current discharge characteristics can be obtained at the same time. In addition, by the addition of the chain carbonate ester and the polysiloxane compound according to the embodiment of the present technology, a significant effect can be obtained even at the time of large current discharge, and a more significant effect can be obtained in the battery in which the charge and discharge cycle progresses; hence, the addition described above is more preferably applied to a secondary battery.

### 3. Third Embodiment

A nonaqueous electrolyte battery according to the third embodiment of the present technology will be described. The nonaqueous electrolyte battery according to the third embodiment is a laminate type nonaqueous electrolyte battery having a laminate film functioning as an exterior member.

### (3-1) Structure of Nonaqueous Electrolyte Battery

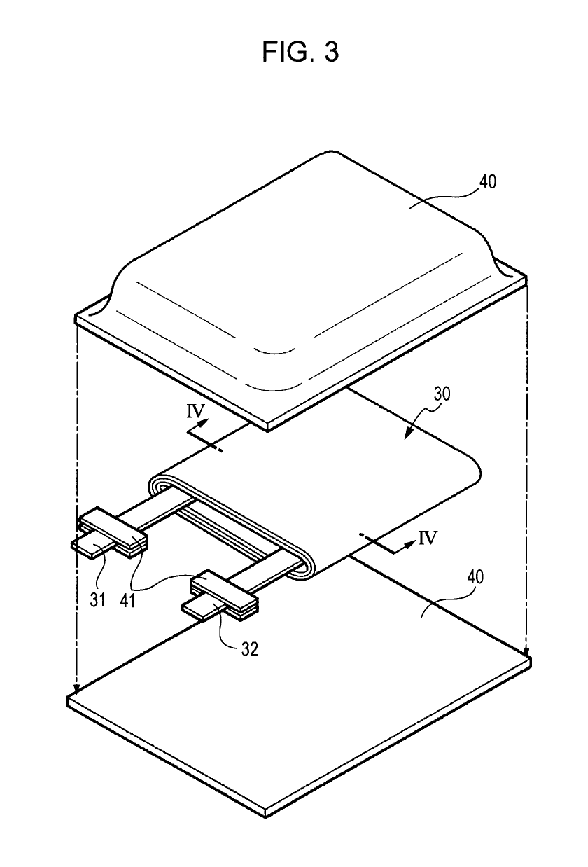

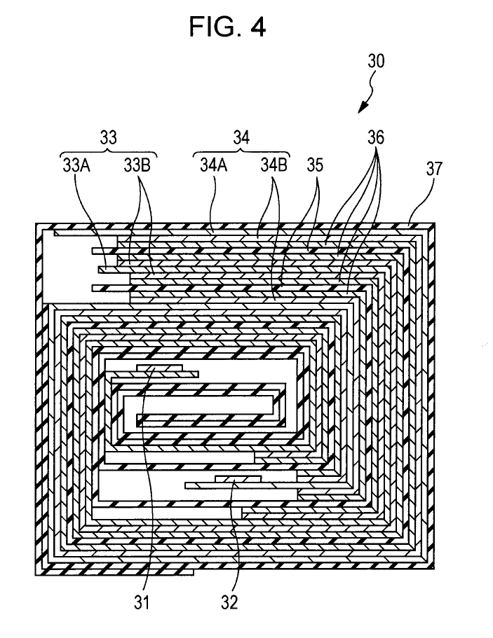

The nonaqueous electrolyte battery according to the third embodiment of the present technology will be described. FIG. 3 shows an exploded perspective structure of the nonaqueous electrolyte battery according to the third embodiment of the present technology, and FIG. 4 is an enlarged cross-sectional view of a wound electrode body 30 shown in FIG. 3 taken along the line IV-IV.

In this nonaqueous electrolyte battery, the wound electrode body 30 provided with a positive electrode lead 31 and a negative electrode lead 32 is primarily received in a film-shaped exterior member 40. A battery structure using this film-shaped exterior member 40 is called a laminate type.

The positive electrode lead 31 and the negative electrode lead 32 are extended, for example, from the inside of the exterior member 40 to the outside in the same direction. The positive electrode lead 31 is formed, for example, of a metal material, such as aluminum, and the negative electrode lead 32 is formed, for example, of a metal material, such as copper, nickel, or stainless steel. These metal materials each have a thin plate shape, a mesh shape, or the like.

The exterior member 40 is formed of an aluminum laminate film in which, for example, a nylon film, an aluminum foil, and a polyethylene film are laminated in this order. This exterior member 40 has the structure in which, for example, two rectangular aluminum laminate films are fused or adhered with an adhesive at peripheral portions thereof so that the polyethylene films face the wound electrode body 30.

Between the exterior member 40 and the positive electrode lead 31 and between the exterior member 40 and the negative electrode lead 32, adhesion films 41 for preventing entry of outside air are provided. This adhesion film 41 is formed of a material having adhesion to the positive electrode lead 31 and the negative electrode lead 32. As the material described above, for example, a polyolefin resin, such as a polyethylene, a polypropylene, a modified polyethylene, or a modified polypropylene, may be mentioned.

In addition, instead of using the aluminum laminate film, the exterior member 40 may be formed of a laminate film having a different laminate structure and may be formed of a polymer film, such as a polypropylene, or a metal film.

FIG. 4 shows a cross-sectional structure of the wound electrode body 30 shown in FIG. 3 taken along the line IV-IV. This wound electrode body 30 is formed by laminating and winding a positive electrode 33 and a negative electrode 34 with separators 35 and electrolytes 36 provided therebetween, and the outermost periphery of the wound electrode body 30 is protected by a protective tape 37.

The positive electrode 33 is formed, for example, of a positive electrode collector 33A and positive electrode active material layers 33B provided on two surfaces thereof, and the coating films derived from the chain carbonate ester represented by the formula (I) and the polysiloxane compound of the formula (II) are formed on the surfaces of the positive electrode.

The negative electrode 34 is formed, for example, of a negative electrode collector 34A and a negative electrode active material layers 34B provided on two surfaces thereof, and the coating films derived from the polysiloxane compound of the formula (II) may be formed on the surfaces of the negative electrode.

The positive electrode 33 and the negative electrode 34 are arranged so that the negative electrode active material layer 34B and the positive electrode active material layer 33B face each other. The structures of the positive electrode collector 33A, the positive electrode active material layer 33B, the negative electrode collector 34A, the negative electrode active material layer 34B, and the separator 35 are similar to the structures of the positive electrode collector 21A, the positive electrode active material layer 21B, the negative electrode collector 22A, the negative electrode active material layer 22B, and the separator 23, respectively, according to the second embodiment.

The electrolyte 36 contains the nonaqueous electrolyte according to the first embodiment described above and a polymer holding this electrolyte and is a so-called gel electrolyte. The gel electrolyte is preferable since high ion conductivity (such as 1 mS/cm or more at room temperature) is obtained and in addition, the electrolyte is prevented from spilling.

### (3-2) Method for Manufacturing Nonaqueous Electrolyte Battery

This nonaqueous electrolyte battery is manufactured, for example, by the following three types of manufacturing methods (a first to a third manufacturing method).

### (3-2-1) First Manufacturing Method

In the first manufacturing method, for example, by a procedure similar to that of the second embodiment in which the positive electrode 21 and the negative electrode 22 are formed, the positive electrode active material layers 33B are first formed on the two surfaces of the positive electrode collector 33A, thereby forming the positive electrode 33. In addition, the negative electrode active material layers 34B are formed on the two surfaces of the negative electrode collector 34A, thereby forming the negative electrode 34.

Next, after a precursor solution containing the nonaqueous electrolyte according to the first embodiment, a polymer compound, and a solvent is prepared and is then applied to the positive electrode 33 and the negative electrode 34, the solvent is then vaporized, so that the gel electrolytes 36 are formed. Subsequently, the positive electrode lead 31 is fitted to the positive electrode collector 33A, and the negative electrode lead 32 is also fitted to the negative electrode collector 34A.

Next, after the positive electrode 33 and the negative electrode 34, which are provided with the electrolytes 36, are laminated with the separators 35 therebetween and are wound in a longitudinal direction, the protective tape 37 is adhered to the outermost periphery of a wound body thus formed, so that the wound electrode body 30 is formed. Finally, for example, after the wound electrode body 30 is sandwiched between two film-shaped pre-exterior members 40, peripheral portions thereof are adhered to each other by heat sealing or the like, so that the wound electrode body 30 is sealed. At this stage, the adhesion films 41 are inserted between the positive electrode lead 31 and the pre-exterior members 40 and between the negative electrode lead 32 and the pre-exterior members 40. Accordingly, the nonaqueous electrolyte battery is formed.

### (3-2-2) Second Manufacturing Method

In the second manufacturing method, first, the positive electrode lead 31 is fitted to the positive electrode 33, and the negative electrode lead 32 is fitted to the negative electrode 34. Next, after the positive electrode 33 and the negative electrode 34 are laminated with the separators 35 provided therebetween and are then wound, the protective tape 37 is adhered to the outermost periphery of a wound laminate thus formed, so that a wound body, which is a precursor of the wound electrode body 30, is formed.

Subsequently, after the wound body is sandwiched between the two film-shaped pre-exterior members 40, peripheral portions thereof except for one peripheral side are adhered by heat sealing or the like, so that the wound body is received in a bag-shaped exterior member 40. Next, an electrolyte composition containing the nonaqueous electrolyte according to the first embodiment, a monomer which is a raw material of a polymer compound, and a polymerization initiator is prepared together with other materials, such as a polymerization inhibitor, if necessary, and is then charged in the bag-shaped exterior member 40, and the opening portion of the exterior member 40 is then sealed by heat sealing or the like. Finally, the polymer compound is formed by heat polymerizing the monomer, thereby forming the gel electrolyte 36. Accordingly, the nonaqueous electrolyte battery is formed.

### (3-2-3) Third Manufacturing Method

In the third manufacturing method, except that the separators 35 are used in each of which a polymer compound is applied on each of the two surfaces thereof, a wound body is first formed and is received in the bag-shaped exterior member 40 as in the above second manufacturing method.

As the polymer applied to the separator 35, for example, a polymer containing vinylidene fluoride as a component, that is, a homopolymer, a copolymer, or a multicomponent copolymer thereof may be mentioned. In particular, for example, there may be mentioned a poly(vinylidene fluoride), a binary copolymer containing vinylidene fluoride and hexafluoropropylene as components, and a ternary copolymer containing vinylidene fluoride, hexafluoropropylene, and chlorotrifluoroethylene as components.

In addition, the polymer compound may contain at least one of other polymers together with the above polymer containing vinylidene fluoride as a component. Subsequently, after the nonaqueous electrolyte according to the first embodiment is charged in the exterior member 40, the opening portion thereof is sealed by heat sealing or the like. Finally, the exterior member 40 is heated while being applied with a load, so that the separators 35 are tightly adhered to the positive electrode 33 and the negative electrode 34 with the polymer compounds provided therebetween. Accordingly, the polymer compound is impregnated with the nonaqueous electrolyte and is then gelled to form the electrolyte 36, so that the nonaqueous electrolyte battery is formed.

When the nonaqueous electrolyte battery formed by one of the above first to the third manufacturing methods is preliminarily charged or charged, the coating film derived from the chain carbonate ester represented by the formula (I) and the coating film derived from the polysiloxane compound of the formula (II) are formed on each surface of the positive electrode. In addition, the coating film derived from the polysiloxane compound of the formula (II) may be formed on each surface of the negative electrode.

### <Effect>

According to the third embodiment, effects similar to those of the second embodiment are obtained.

### 4. Fourth Embodiment

A nonaqueous electrolyte battery according to a fourth embodiment of the present technology will be described. The nonaqueous electrolyte battery according to the fourth embodiment is a laminate type nonaqueous electrolyte battery having a laminate film as an exterior member and is similar to that of the third embodiment except that the same nonaqueous electrolyte battery as that of the first embodiment is used. Hence, hereinafter, the structure will be described in detail focusing on points different from those of the third embodiment.

### (4-1) Structure of Nonaqueous Electrolyte Battery

In the nonaqueous electrolyte battery according to the fourth embodiment of the present technology, a nonaqueous electrolyte is used instead of the gel electrolyte 36. Hence, the wound electrode body 30 has the structure in which the electrolyte 36 is not provided, and the separators 35 are impregnated with the nonaqueous electrolyte.

### (4-2) Method for Manufacturing Nonaqueous Electrolyte Battery

For example, this nonaqueous electrolyte battery is manufactured as described below.

First, for example, a positive electrode mixture is prepared by mixing a positive electrode active material, a binder, and a conducting agent and is then dispersed in a solvent, such as N-methyl-2-pyrrolidone, so that a positive electrode mixture slurry is formed. Next, this positive electrode mixture slurry is applied to two surfaces of the positive electrode collector 33A and is then dried and compression-molded to form the positive electrode active material layers 33B, so that the positive electrode 33 is formed. Subsequently, for example, the positive electrode lead 31 is fitted to the positive electrode collector 33A by ultrasonic welding, spot welding, or the like.

In addition, a negative electrode mixture is prepared, for example, by mixing a negative electrode material and a binder and is then dispersed in a solvent, such as N-methyl-2-pyrrolidone, so that a negative electrode mixture slurry is formed. Next, this negative electrode mixture slurry is applied to two surfaces of the negative electrode collector 34A and is then dried and compression-molded to form the negative electrode active material layers 34B, so that the negative electrode 34 is formed. Subsequently, for example, the negative electrode lead 32 is fitted to the negative electrode collector 33A by ultrasonic welding, spot welding, or the like.

Next, after the positive electrode 33 and the negative electrode 34 are wound with the separators 35 provided therebetween and were received in the exterior member 40, the nonaqueous electrolyte according to the first embodiment is charged in the exterior member 40, and the exterior member 40 is then sealed. Accordingly, the nonaqueous electrolyte battery shown in FIGS. 3 and 4 is obtained.

### <Effect>

According to the fourth embodiment, effects similar to those of the second embodiment are obtained.

### 5. Fifth Embodiment

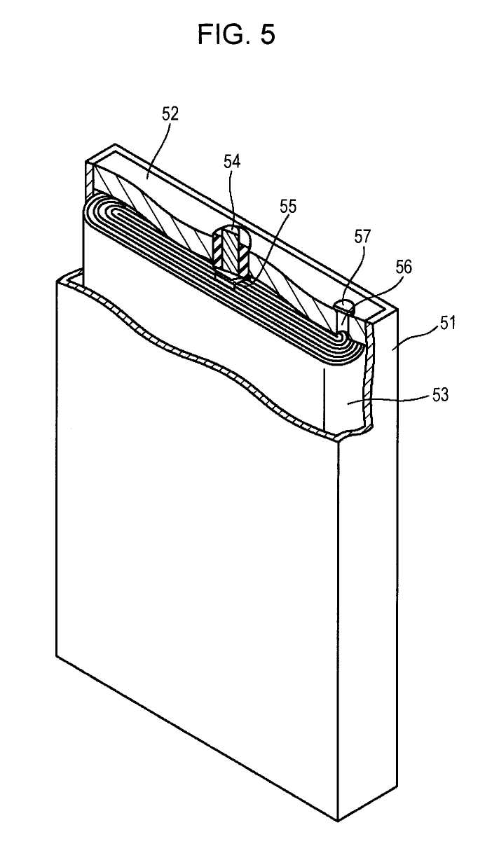

A structural example of a nonaqueous electrolyte battery 20 according to the fifth embodiment of the present technology will be described. The nonaqueous electrolyte battery 20 according to the fifth embodiment of the present technology has a square shape as shown in FIG. 5.

This nonaqueous electrolyte battery 20 is formed as described below. As shown in FIG. 5, first, a wound electrode body 53 is received in an exterior can 51 having a square shape formed of a metal, such as aluminum (Al) or iron (Fe).

In addition, after an electrode pin 54 provided in a battery lid 52 is connected to an electrode terminal 55 extended from the wound electrode body 53, sealing is performed by the battery lid 52. Next, a nonaqueous electrolyte containing the chain carbonate ester represented by the formula (I) and the polysiloxane compound of the formula (II) is charged through a nonaqueous electrolyte inlet 56, and sealing is performed by a sealing member 57. When the battery thus formed is charged or preliminarily charged, the coating film derived from the chain carbonate ester represented by the formula (I) is formed on each surface of a positive electrode, and the polysiloxane compound of the formula (II) is also deposited on each surface of the negative electrode 34, so that the nonaqueous electrolyte battery 20 according to the fifth embodiment of the present technology is formed.

In this embodiment, the wound electrode body 53 is obtained by laminating and winding the positive electrode and the negative electrode with separators provided therebetween. Since the positive electrode, the negative electrode, the separator, and the nonaqueous electrolyte are similar to those of the first embodiment, detailed description thereof is omitted.

### <Effect>

In the nonaqueous electrolyte battery 20 according to the fifth embodiment of the present technology, effects similar to those of the second embodiment can be obtained.

### 6. Sixth Embodiment

A nonaqueous electrolyte battery according to the sixth embodiment of the present technology will be described. The nonaqueous electrolyte battery according to the sixth embodiment is a laminate type nonaqueous electrolyte battery in which an electrode body formed by laminating a positive electrode and a negative electrode is covered with a laminate film functioning as an exterior member and which is similar to that of the third embodiment except for the structure of the electrode body. Accordingly, hereinafter, only the electrode body according to the sixth embodiment will be described.

### [Positive Electrode and Negative Electrode]

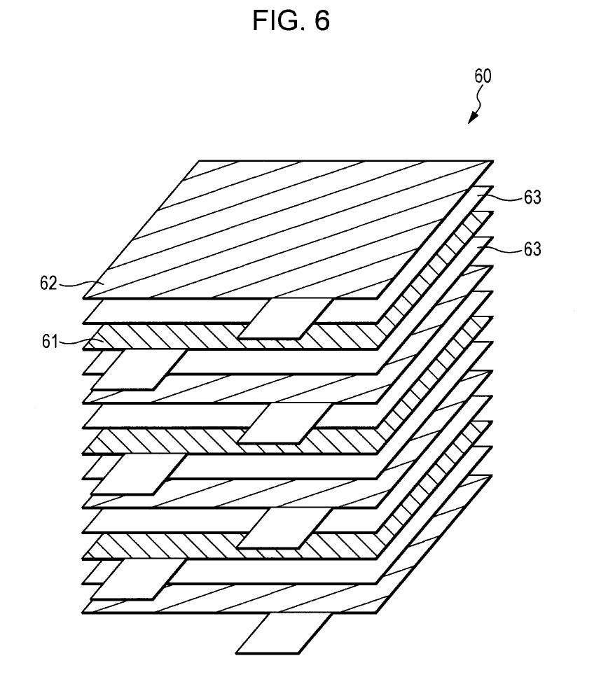

As shown in FIG. 6, a positive electrode 61 is obtained by forming positive electrode active material layers on two surfaces of a rectangular positive electrode collector. The positive electrode collector of the positive electrode 61 is preferably formed integrally with a positive electrode terminal. In addition, as in the case described above, a negative electrode 62 is also formed by forming negative electrode active material layers on a rectangular negative electrode collector.

The positive electrode 61, a separator 63, the negative electrode 62, and a separator 63 are laminated in this order, so that a laminated electrode body 60 is formed. In the laminated electrode body 60, a laminated structure of the electrodes may be maintained by adhesion using an insulating tape or the like. The laminated electrode body 60 is covered, for example, with a laminate film functioning as an exterior member and is sealed together with a nonaqueous electrolyte to form the battery. In addition, a gel electrolyte may also be used instead of using a nonaqueous electrolyte.

Particular examples of the present technology will be described in detail. However, the present technology is not limited thereto.

Chain carbonate esters used in the following Examples 1 to 3 are as described below.

Chemical A: Ditetradecyl carbonate (C₁₄H₂₉O)₂CO
Chemical B: Ditridecyl carbonate (C₁₃H₂₇O)₂CO
Chemical C: Dieicosyl carbonate (C₂₀H₄₁O)₂CO
Chemical D: Methyl tetradecyl carbonate (CH₃O)(C₁₄H₂₉O)CO
Chemical E: Ethyl tetradecyl carbonate (C₂H_{S}O)(C₁₄H₂₉O)CO
Chemical F: Didodecyl carbonate (C₁₂H₂₅O)₂CO
Chemical G: Didocosyl carbonate (C₂₂H₄₅O)₂CO

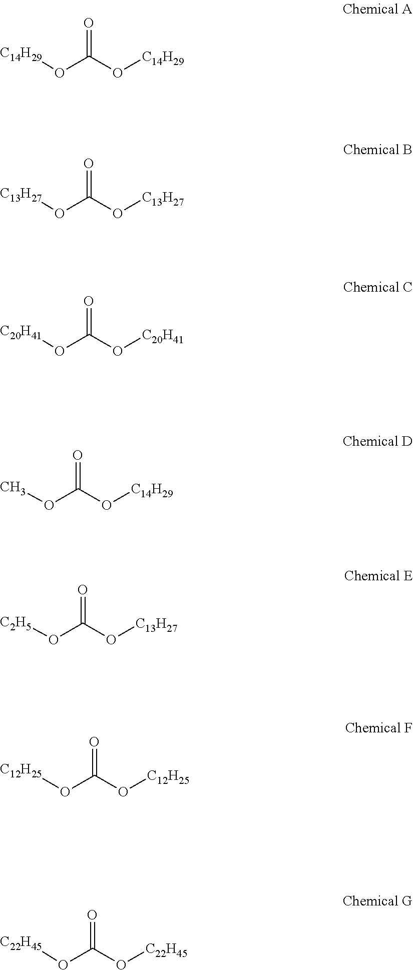

In addition, polysiloxane compounds used in the following Examples 1 to 3 are as described below.

### Chemical H: Polydimethylsiloxane

### Chemical I: Polymethylphenylsiloxane

Chemical J: Epoxy-modified polysiloxane
Chemical K: Carbinol-modified polysiloxane

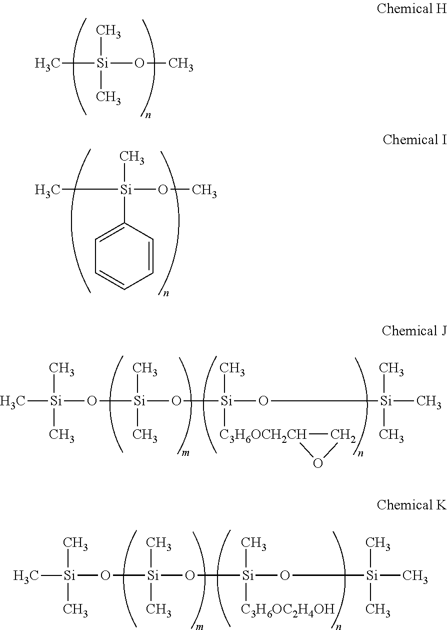

### Example 1

In Example 1, the addition amounts of the chain carbonate ester and the polysiloxane compound contained in a nonaqueous electrolyte charged in a battery were each changed, and the battery characteristics were investigated.

### Example 1-1

### Formation of Positive Electrode

First, 94 parts by mass of a lithium cobalt composite oxide (LiCoO₂) as a positive electrode active material, 3 parts by mass of graphite as a conducting agent, 3 parts by mass of a poly(vinylidene fluoride) (PVdF) as a binder were mixed together, and N-methylpyrrolidone was added, so that a positive electrode mixture slurry was obtained. Next, after this positive electrode mixture slurry was uniformly applied to two surfaces of an aluminum foil having a thickness of 20 μm and was then dried, compression molding was carried out by a roll press machine to form positive electrode active material layers each having a volume density of 40 mg/cm², so that a positive electrode sheet was formed. Finally, the positive electrode sheet was cut to have a width of 50 mm and a length of 300 mm, and a positive electrode lead made of aluminum (Al) was fitted to one end of a positive electrode collector by welding, so that a positive electrode was formed.

### [Formation of Negative Electrode]

First, 97 parts by mass of graphite as a negative electrode active material and 3 parts by mass of a poly(vinylidene fluoride) (PVdF) as a binder were mixed together, and N-methylpyrrolidone was added, so that a negative electrode mixture slurry was obtained. Next, after this negative electrode mixture slurry was uniformly applied to two surfaces of a copper foil having a thickness of 15 μm to be formed as a negative electrode collector and was then dried, compression molding was carried out by a roll press machine to form negative electrode active material layers each having a volume density of 20 mg/cm², so that a negative electrode sheet was formed. Finally, the negative electrode sheet was cut to have a width of 50 mm and a length of 300 mm, and a negative electrode lead made of nickel (Ni) was fitted to one end of the negative electrode collector by welding, so that a negative electrode was formed.

### [Preparation of Nonaqueous Electrolyte]

A mixed solution containing ethylene carbonate (EC), ethyl methyl carbonate (EMC), lithium hexafluorophosphate (LiPF₆), and vinylene carbonate (VC) at a mass ratio of 25:60:14:1, respectively, was prepared. In this case, ethyl methyl carbonate (EMC) was used as a low viscosity solvent. Next, 0.03 percent by mass of Chemical A, ditetradecyl carbonate, as the chain carbonate ester and 0.05 percent by mass of Chemical H, polydimethylsiloxane (kinetic viscosity 20 cSt), as the polysiloxane compound were added to this mixed solution, so that a nonaqueous electrolyte was prepared. In this example, the kinetic viscosity of a polydimethylsiloxane was a kinetic viscosity in an environment at 25° C.

### [Assembly of Battery]

The positive electrode, a separator, the negative electrode, and a separator were laminated in this order and were then wound, so that a wound electrode body was formed. The separators were formed by applying a poly(vinylidene fluoride) (PVdF) on two surfaces of a 10 micrometer-thick fine porous polyethylene film to have a thickness of 2 μm at each side. Next, the wound electrode body was covered with an exterior member of an aluminum laminate film, and peripheral portions of the exterior member except one peripheral side were heat sealed.

Next, 2 g of the nonaqueous electrolyte was charged through an opening portion of the exterior member, and the opening portion thereof was then heat-sealed under reduced pressure environment. Then, when pressure molding at 90° C. was performed from the outside of the battery, a laminate type nonaqueous electrolyte battery was formed in which the nonaqueous electrolyte was impregnated into the poly(vinylidene fluoride) (PVdF) and was gelled.

In this example, the positive electrode and the negative electrode were designed so that a designed capacity of the battery thus formed was 800 mAh.

### Example 1-2 to Example 1-28

Except that the addition amounts of Chemical A, ditetradecyl carbonate, which was the chain carbonate ester, and Chemical H, polydimethylsiloxane (kinetic viscosity 20 cSt), which was the polysiloxane compound, mixed in the nonaqueous electrolyte were changed as shown in Table 1, laminate type nonaqueous electrolyte batteries were formed in a manner similar to that of Example 1-1.

### Comparative Example 1-1

A laminate type nonaqueous electrolyte battery was formed in a manner similar to that of Example 1-1 except that Chemical A, ditetradecyl carbonate, which was the chain carbonate ester, and Chemical H, polydimethylsiloxane (kinetic viscosity 20 cSt), which was the polysiloxane compound, were not added to the nonaqueous electrolyte.

### Comparative Example 1-2

A laminate type nonaqueous electrolyte battery was formed in a manner similar to that of Example 1-1 except that the addition amount of Chemical A, ditetradecyl carbonate, which was the chain carbonate ester, was set to 0.2 percent by mass to the nonaqueous electrolyte, and Chemical H, polydimethylsiloxane (kinetic viscosity 20 cSt), which was the polysiloxane compound, was not added.

### Comparative Example 1-3

A laminate type nonaqueous electrolyte battery was formed in a manner similar to that of Example 1-1 except that the addition amount of Chemical H, polydimethylsiloxane (kinetic viscosity 20 cSt), which was the polysiloxane compound, was set to 0.2 percent by mass to the nonaqueous electrolyte, and Chemical A, ditetradecyl carbonate, which was the chain carbonate ester, was not added.

### [Evaluation of Battery]

### (a) Cycle Characteristics

After each of the batteries of Examples and Comparative Examples formed as described above was placed in an environment at 23° C. and was then charged by a constant current of 800 mA (1 ItA) to a battery voltage of 4.2 V, discharge was performed at a constant battery voltage of 4.2 V for a total charge time of 3 hours. Subsequently, after the battery was left for 10 minutes, constant-current discharge was carried out at 800 mA (1 ItA) to a voltage of 3.0 V, and this discharge capacity at this time was measured as a first time capacity. The charge and discharge were repeatedly performed under charge-discharge conditions similar to those described above, and a discharge capacity at a 200th cycle was measured. The capacity retention rate at a 200th cycle was calculated from the following equation. 200th-cycle capacity retention rate [%]=100×(200th-cycle discharge capacity/first time capacity)

### (b) Large Current Discharge Characteristics

Each of the batteries of Examples and Comparative Examples formed as described above was placed in an environment at 23° C. and was then charged by a constant current of 800 mA (1 ItA) to a battery voltage of 4.2V, and discharge was then performed at a constant battery voltage of 4.2 V for a total charge time of 3 hours. Subsequently, after the battery was left for 10 minutes, constant-current discharge was carried out at 160 mA (0.2 ItA) to a voltage of 3.0 V, and a 0.2-ItA discharge capacity was measured. Then, after charge was performed under conditions similar to the above charge conditions, and the battery was then left for 10 minutes, constant-current discharge was carried out at 4,000 mA (5 ItA) to a voltage of 3.0 V, and a 5-ItA discharge capacity was measured. The capacity retention rate of 5-ItA discharge to 0.2-ItA discharge was calculated from the following equation.

5-ItA discharge capacity retention rate [%]=100×(5-ItA discharge capacity/0.2-ItA discharge capacity)

Evaluation results are shown in the following Table 1.

TABLE 1

| | ADDITIVE | | | | |
|---|---|---|---|---|---|
| | ADDITION | | | | |
| | AMOUNT OF | | | 200th- | 5-ltA |
| | DITETRADECYL | | | CYCLE | DISCHARGE |
| | CARBONATE | ADDITION AMOUNT OF | | CAPACITY | CAPACITY |
| | (PERCENT BY | POLYDIMETHYLSILOXANE | MASS | RETENTION | RETENTION |
| | MASS) | (PERCENT BY MASS) | RATIO | RATE [%] | RATE [%] |
| EXAMPLE 1-1 | 0.03 | 0.05 | 3:5 | 81.0 | 31.5 |
| EXAMPLE 1-2 | 0.03 | 0.2 | 3:20 | 80.7 | 34.3 |
| EXAMPLE 1-3 | 0.05 | 0.03 | 5:3 | 83.0 | 24.2 |
| EXAMPLE 1-4 | 0.05 | 0.05 | 1:1 | 82.7 | 31.0 |
| EXAMPLE 1-5 | 0.05 | 0.2 | 1:4 | 82.0 | 34.1 |
| EXAMPLE 1-6 | 0.05 | 0.3 | 1:6 | 81.5 | 34.4 |
| EXAMPLE 1-7 | 0.05 | 0.5 | 1:10 | 81.0 | 34.4 |
| EXAMPLE 1-8 | 0.05 | 1.0 | 1:20 | 80.0 | 34.3 |
| EXAMPLE 1-9 | 0.1 | 0.05 | 2:1 | 84.1 | 30.7 |
| EXAMPLE 1-10 | 0.2 | 0.03 | 20:3 | 85.4 | 21.9 |
| EXAMPLE 1-11 | 0.2 | 0.05 | 4:1 | 85.4 | 28.6 |
| EXAMPLE 1-12 | 0.2 | 0.2 | 1:1 | 85.2 | 34.0 |
| EXAMPLE 1-13 | 0.2 | 0.5 | 2:5 | 83.0 | 34.1 |
| EXAMPLE 1-14 | 0.2 | 1.0 | 1:5 | 81.5 | 34.2 |
| EXAMPLE 1-15 | 0.25 | 1.0 | 1:4 | 82.3 | 34.0 |
| EXAMPLE 1-16 | 0.4 | 0.2 | 2:1 | 85.4 | 30.8 |
| EXAMPLE 1-17 | 0.5 | 0.05 | 10:1 | 85.5 | 21.5 |
| EXAMPLE 1-18 | 0.5 | 0.2 | 5:2 | 85.4 | 29.7 |
| EXAMPLE 1-19 | 0.5 | 0.5 | 1:1 | 83.9 | 32.0 |
| EXAMPLE 1-20 | 0.5 | 1.0 | 1:2 | 82.5 | 32.1 |
| EXAMPLE 1-21 | 0.5 | 1.1 | 5:11 | 81.6 | 32.2 |
| EXAMPLE 1-22 | 1.0 | 0.05 | 20:1 | 85.5 | 20.9 |
| EXAMPLE 1-23 | 1.0 | 0.4 | 5:2 | 84.5 | 28.5 |
| EXAMPLE 1-24 | 1.0 | 0.5 | 2:1 | 84.2 | 30.6 |
| EXAMPLE 1-25 | 1.0 | 1.0 | 1:1 | 82.7 | 30.8 |
| EXAMPLE 1-26 | 1.0 | 1.1 | 10:11 | 81.8 | 31.0 |
| EXAMPLE 1-27 | 1.1 | 0.5 | 11:5 | 84.5 | 26.6 |
| EXAMPLE 1-28 | 1.1 | 1.0 | 11:10 | 82.9 | 28.1 |
| COMPARATIVE | 0 | 0 | — | 76.9 | 34.5 |
| EXAMPLE 1-1 | | | | | |
| COMPARATIVE | 0.2 | 0 | — | 85.4 | 9.1 |
| EXAMPLE 1-2 | | | | | |
| COMPARATIVE | 0 | 0.2 | — | 76.4 | 34.3 |
| EXAMPLE 1-3 | | | | | |

As shown in Table 1, although the cycle characteristics of Comparative Example 1-2 in which only the chain carbonate ester was added to the nonaqueous electrolyte were improved as compared to those of Comparative Example 1-1 in which both the chain carbonate ester and the polysiloxane compound were not added to the nonaqueous electrolyte, the large current discharge characteristics was remarkably degraded. In addition, in Comparative Example 1-3 in which only the polysiloxane compound was added, the cycle characteristics and the large current discharge characteristics were equivalent to the respective characteristics of Comparative Example 1-1.

On the other hand, in each Example which used the nonaqueous electrolyte added with both the chain carbonate ester and the polysiloxane compound, the capacity retention rate was as high as 80% or more when the cycle progressed, and in addition, the large current discharge characteristics was 20% or more; hence, the cycle characteristics and the large current discharge characteristics could be satisfied at the same time.

In particular, in view of the cycle characteristics, it is preferable that the addition amount of the chain carbonate ester be 0.05 percent by mass or more, the addition amount of the polysiloxane compound be 1.0 percent by mass or less, the addition amount of the polysiloxane compound be not more than 4 times that of the chain carbonate ester. When the above ranges are satisfied, the cycle characteristics can be maintained at 82% or more.

In addition, in view of the large current discharge characteristics, it is preferable that the addition amount of the chain carbonate ester be 1.0 percent by mass or less, the addition amount of the polysiloxane compound be 0.05 percent by mass or more, and the addition amount of the chain carbonate ester be not more than 2 times that of the polysiloxane compound. When these ranges are satisfied, the large current discharge characteristics can be maintained at 30% or more.

It is believed that since the addition effect of the chain carbonate ester and that of the polysiloxane compound have an interaction with each other, there is a desirable mass ratio range therebetween.

In addition, it was found that when the addition amounts of the chain carbonate ester and the polysiloxane compound and the addition mass ratio therebetween were in the respective ranges described above, the battery characteristics could be more significantly improved. That is, in Examples 4, 5, 9, 12, 13, 15, 16, 19, 20, 24, and 25, in each of which the addition amounts of the chain carbonate ester and the polysiloxane compound and the addition mass ratio therebetween were all in the respective ranges described above, the cycle characteristics was 82% or more, and the large current discharge characteristics was 30.7% or more, so that excellent battery characteristics could be realized.

### Example 2

In Example 2, the materials for the chain carbonate ester and for the polysiloxane compound were changed, and the addition effects were investigated.

### Example 2-1

A laminate type nonaqueous electrolyte battery was formed in a manner similar to that of Example 1-12 except that Chemical B, ditridecyl carbonate, was used as the chain carbonate ester.

### Example 2-2

A laminate type nonaqueous electrolyte battery was formed in a manner similar to that of Example 1-12 except that Chemical C, dieicosyl carbonate, was used as the chain carbonate ester.

### Example 2-3

A laminate type nonaqueous electrolyte battery was formed in a manner similar to that of Example 1-12 except that Chemical D, methyl tetradecyl carbonate, was used as the chain carbonate ester.

### Example 2-4

A laminate type nonaqueous electrolyte battery was formed in a manner similar to that of Example 1-12 except that Chemical E, ethyl tetradecyl carbonate, was used as the chain carbonate ester.

### Example 2-5

A laminate type nonaqueous electrolyte battery was formed in a manner similar to that of Example 1-12 except that a polydimethylsiloxane having a kinetic viscosity of 0.5 cSt was used as the polysiloxane compound.

### Example 2-6

A laminate type nonaqueous electrolyte battery was formed in a manner similar to that of Example 1-12 except that a polydimethylsiloxane having a kinetic viscosity of 5 cSt was used as the polysiloxane compound.

### Example 2-7

A laminate type nonaqueous electrolyte battery was formed in a manner similar to that of Example 1-12 except that a polydimethylsiloxane having a kinetic viscosity of 50 cSt was used as the polysiloxane compound.

### Example 2-8

A laminate type nonaqueous electrolyte battery was formed in a manner similar to that of Example 1-12 except that a polydimethylsiloxane having a kinetic viscosity of 500 cSt was used as the polysiloxane compound.

### Example 2-9

A laminate type nonaqueous electrolyte battery was formed in a manner similar to that of Example 1-12 except that Chemical I, polymethylphenylsiloxane, was used as the polysiloxane compound.

### Comparative Example 2-1

A laminate type nonaqueous electrolyte battery was formed in a manner similar to that of Example 1-12 except that Chemical F, didodecyl carbonate, was used as the chain carbonate ester.

### Comparative Example 2-2

A laminate type nonaqueous electrolyte battery was formed in a manner similar to that of Example 1-12 except that Chemical G, didocosyl carbonate, was used as the chain carbonate ester.

### Comparative Example 2-3

A laminate type nonaqueous electrolyte battery was formed in a manner similar to that of Example 1-12 except that Chemical J, epoxy-modified polysiloxane, was used as the polysiloxane compound.

### Comparative Example 2-4

A laminate type nonaqueous electrolyte battery was formed in a manner similar to that of Example 1-12 except that Chemical K, Carbinol-modified polysiloxane, was used as the polysiloxane compound.

### [Evaluation of Battery]

### (a) Cycle Characteristics

### (b) Large Current Discharge Characteristics

The capacity retention rate at a 200th cycle and 5-ItA discharge capacity retention rate were evaluated as in Example 1.

Evaluation results are shown in the following Table 2.

TABLE 2

| | | | | 200th-CYCLE | 5-ltA DISCHARGE |
|---|---|---|---|---|---|
| | CHAIN CARBONATE | POLYSILOXANE ADDITIVE | | CAPACITY | CAPACITY |
| | ESTER ADDITIVE | | KINETIC | RETENTION | RETENTION RATE |
| | MATERIAL | MATERIAL | VISCOSITY [cSt] | RATE [%] | [%] |
| EXAMPLE 2-1 | DITRIDECYL | POLYDIMETHYLSILOXANE | 20 | 82.8 | 31.7 |
| | CARBONATE | | | | |
| EXAMPLE 2-2 | DIEICOSYL | POLYDIMETHYLSILOXANE | 20 | 82.1 | 30.9 |
| | CARBONATE | | | | |
| EXAMPLE 2-3 | METHYL TETRADECYL | POLYDIMETHYLSILOXANE | 20 | 83.5 | 34.0 |
| | CARBONATE | | | | |
| EXAMPLE 2-4 | ETHYL TETRADECYL | POLYDIMETHYLSILOXANE | 20 | 83.4 | 33.9 |
| | CARBONATE | | | | |
| EXAMPLE 2-5 | DITETRADECYL | POLYDIMETHYLSILOXANE | 0.5 | 85.1 | 29.6 |
| | CARBONATE | | | | |
| EXAMPLE 2-6 | DITETRADECYL | POLYDIMETHYLSILOXANE | 5 | 85.0 | 33.2 |
| | CARBONATE | | | | |
| EXAMPLE 2-7 | DITETRADECYL | POLYDIMETHYLSILOXANE | 50 | 84.8 | 34.0 |
| | CARBONATE | | | | |
| EXAMPLE 2-8 | DITETRADECYL | POLYDIMETHYLSILOXANE | 500 | 84.5 | 30.0 |
| | CARBONATE | | | | |
| EXAMPLE 2-9 | DITETRADECYL | POLYMETHYLPHENYLSILOXANE | — | 84.7 | 31.7 |
| | CARBONATE | | | | |
| COMPARATIVE | DIDODECYL | POLYDIMETHYLSILOXANE | 20 | 79.3 | 32.0 |
| EXAMPLE 2-1 | CARBONATE | | | | |
| COMPARATIVE | DIDOCOSYL | POLYDIMETHYLSILOXANE | 20 | 79.6 | 22.7 |
| EXAMPLE 2-2 | CARBONATE | | | | |
| COMPARATIVE | DITETRADECYL | EPOXY-MODIFIED | 25 | 19.5 | 0 |
| EXAMPLE 2-3 | CARBONATE | POLYSILOXANE | | | |
| COMPARATIVE | DITETRADECYL | CARBINOL-MODIFIED | 90 | 24.6 | 0 |
| EXAMPLE 2-4 | CARBONATE | POLYSILOXANE | | | |

In Examples 2-1 and 2-2 in which Chemical B, ditridecyl carbonate (carbon number of the hydrocarbon group: 13) and Chemical C, dieicosyl carbonate (carbon number of the hydrocarbon group: 20) were used, respectively, instead of using ditetradecyl carbonate (carbon number of the hydrocarbon group: 14) in Example 1-12, the cycle characteristics and the large current discharge characteristics could both be maintained high. In addition, in Examples 2-3 and 2-4 in each of which the number of carbon atoms of one of the two hydrocarbon groups of the chain carbonate ester was 14, as is the case described above, the cycle characteristics and the large current discharge characteristics could both be maintained high.

In each of the cases in which polydimethylsiloxanes having kinetic viscosities of 0.5 cSt, 5 cSt, 50 cSt, and 500 cSt were used instead of using a polydimethylsiloxane (kinetic viscosity 20 cSt) in Example 1-12, the cycle characteristics and the large current discharge characteristics could both be maintained high as in the above cases.

In addition, in Example 2-9 in which a polymethylphenylsiloxane was used as the polysiloxane compound, effects similar to those of the other examples in which a polydimethylsiloxane was used could be obtained.

On the other hand, it was found that as shown in Comparative Examples 2-1 and 2-2, when didodecyl carbonate having 12 carbon atoms and didocosyl carbonate having 22 carbon atoms were each used as the chain carbonate ester, an effect of improving the cycle characteristics was small even if the polysiloxane compound was used together therewith. Accordingly, it is believed that a chain carbonate ester having 13 to 20 carbon atoms be preferably used.

Furthermore, in Comparative Examples 2-3 and 2-4, in each of which a polysiloxane compound partially incorporating an organic group was used, the cycle characteristics and the large current discharge characteristics were not good, and in particular, the large current discharge characteristics were considerably degraded. Hence, it was found that as the polysiloxane compound, a polydimethylsiloxane or a polymethylphenylsiloxane was preferable.

### Example 3

In Example 3, the composition of the nonaqueous solvent in the nonaqueous electrolyte was changed, and the addition effect of the carbonate ester and that of the polysiloxane compound of the present technology were investigated.

### Example 3-1

A laminate type nonaqueous electrolyte battery was formed in a manner similar to that of Example 1-12 except that dimethyl carbonate (DMC) was used as a low viscosity solvent instead of using ethyl methyl carbonate (EMC). That is, a nonaqueous electrolyte was prepared by adding 0.2 percent by mass of ditetradecyl carbonate and 0.2 percent by mass of a polydimethylsiloxane to a mixed solution of ethylene carbonate (EC), dimethyl carbonate (DMC), lithium hexafluorophosphate (LiPF₆), and vinylene carbonate (VC) at a mass ratio of 25:60:14:1, respectively.

### Example 3-2

A laminate type nonaqueous electrolyte battery was formed in a manner similar to that of Example 1-12 except that dimethyl carbonate (DMC) and ethyl methyl carbonate (EMC), the volumes of which were equal to each other, were used as a low viscosity solvent. That is, a nonaqueous electrolyte was prepared by adding 0.2 percent by mass of ditetradecyl carbonate and 0.2 percent by mass of a polydimethylsiloxane to a mixed solution of ethylene carbonate (EC), dimethyl carbonate (DMC), ethyl methyl carbonate (EMC), lithium hexafluorophosphate (LiPF₆): and vinylene carbonate (VC) at a mass ratio of 25:30:30:14:1, respectively.

### Example 3-3

A laminate type nonaqueous electrolyte battery was formed in a manner similar to that of Example 1-12 except that dimethyl carbonate (DMC) and diethyl carbonate (DEC), the volumes of which were equal to each other, were used as a low viscosity solvent. That is, a nonaqueous electrolyte was prepared by adding 0.2 percent by mass of ditetradecyl carbonate and 0.2 percent by mass of a polydimethylsiloxane to a mixed solution of ethylene carbonate (EC), dimethyl carbonate (DMC), diethyl carbonate (DEC), lithium hexafluorophosphate (LiPF₆): and vinylene carbonate (VC) at a mass ratio of 25:30:30:14:1, respectively.

### Example 3-4

A laminate type nonaqueous electrolyte battery was formed in a manner similar to that of Example 1-12 except that ethyl methyl carbonate (EMC) and diethyl carbonate (DEC), the volumes of which were equal to each other, were used as a low viscosity solvent. That is, a nonaqueous electrolyte was prepared by adding 0.2 percent by mass of ditetradecyl carbonate and 0.2 percent by mass of a polydimethylsiloxane to a mixed solution of ethylene carbonate (EC), ethyl methyl carbonate (EMC), diethyl carbonate (DEC), lithium hexafluorophosphate (LiPF₆), and vinylene carbonate (VC) at a mass ratio of 25:30:30:14:1, respectively.

### Comparative Example 3-1

A laminate type nonaqueous electrolyte battery was formed in a manner similar to that of Example 1-12 except that diethyl carbonate (DEC) was used instead of using ethyl methyl carbonate (EMC). That is, a nonaqueous electrolyte was prepared by adding 0.2 percent by mass of ditetradecyl carbonate and 0.2 percent by mass of a polydimethylsiloxane to a mixed solution of ethylene carbonate (EC), diethyl carbonate (DEC), lithium hexafluorophosphate (LiPF₆), and vinylene carbonate (VC) at a mass ratio of 25:60:14:1, respectively.

### [Evaluation of Battery]

### (a) Cycle Characteristics

### (b) Large Current Discharge Characteristics

The capacity retention rate at a 200th cycle and 5-ItA discharge capacity retention rate were evaluated as in Example 1.

Evaluation results are shown in the following Table 3.

TABLE 3

| | ADDITIVE | | | | 5-ltA |
|---|---|---|---|---|---|
| | ADDITION AMOUNT | | | 200th-CYCLE | DISCHARGE |
| | OF DITETRADECYL | ADDITION AMOUNT OF | | CAPACITY | CAPACITY |
| | CARBONATE | POLYDIMETHYLSILOXANE | | RETENTION | RETENTION |
| | (PERCENT BY MASS) | (PERCENT BY MASS) | LOW VISCOSITY SOLVENT | RATE [%] | RATE [%] |
| EXAMPLE 3-1 | 0.2 | 0.2 | DIMETHYL CARBONATE | 84.8 | 34.5 |
| EXAMPLE 3-2 | 0.2 | 0.2 | DIMETHYL CARBONATE/ | 85.0 | 34.4 |
| | | | ETHYL METHYL CARBONATE | | |
| EXAMPLE 3-3 | 0.2 | 0.2 | DIMETHYL CARBONATE/ | 84.0 | 32.0 |
| | | | DIETHYL CARBONATE | | |
| EXAMPLE 3-4 | 0.2 | 0.2 | ETHYL METHYL CARBONATE/ | 83.5 | 31.4 |
| | | | DIETHYL CARBONATE | | |
| COMPARATIVE | 0.2 | 0.2 | DIETHYL CARBONATE | 76.0 | 8.2 |
| EXAMPLE 3-1 | | | | | |

As shown in Table 3, it was found that excellent cycle characteristics and large current discharge characteristics were simultaneously obtained when dimethyl carbonate (DMC) and ethyl methyl carbonate (EMC) were used alone or in combination as a nonaqueous solvent. The reason for this is that since dimethyl carbonate and ethyl methyl carbonate each have a low viscosity among various carbonate solvents, an increase in viscosity and a decrease in electrical conductivity of the nonaqueous electrolyte, which occurred when only the solvent of Comparative Examples was used, can be suppressed. Accordingly, at least one of dimethyl carbonate (DMC) and ethyl methyl carbonate (EMC) is preferably used for the nonaqueous electrolyte.

### 7. Other Embodiments

The present technology is not limited to the embodiments described above, and various modifications and applications may be performed without departing from the sprit and scope of the present technology.

For example, although the batteries having a laminate type, a cylindrical type, and a square type battery structure have been described in the above embodiments and examples, the battery is not limited thereto. For example, the present technology may also be applied to a battery having another battery structure, such as a coin type or a button type battery structure, and a battery having a laminated structure in which electrodes are laminated, and effects similar to those described above can also be obtained. In addition, as for the structure of the electrode body, besides the wound type structure, various structures, such as a lamination type and a zigzag type structure, may also be used.

The present disclosure contains subject matter related to that disclosed in Japanese Priority Patent Application JP 2010-188762 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A nonaqueous electrolyte comprising:
an electrolyte salt;
at least one of dimethyl carbonate and ethyl methyl carbonate;
a chain carbonate ester represented by formula (I); and
a polysiloxane compound represented by formula (II) 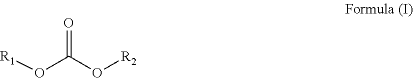
(R₁ represents CₙH₂ₙ₊₁, and n represents an integer of 13 to 20; and R₂ represents CₙH₂ₙ₊₁, and n represents an integer of 1 to 20), 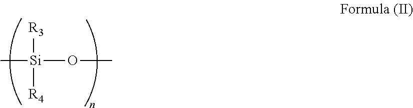
(R₃ and R₄ each represent hydrogen (H), an alkyl group having 1 to 50 carbon atoms, or a phenyl group).

2. The nonaqueous electrolyte according to claim 1,
wherein the content of the chain carbonate ester is in a range of 0.05 to 1.0 percent by mass.

3. The nonaqueous electrolyte according to claim 1,
wherein the content of the polysiloxane compound is in a range of 0.05 to 1.0 percent by mass.

4. The nonaqueous electrolyte according to claim 1,
wherein the mass ratio of the content of the chain carbonate ester to the content of the polysiloxane compound is in a range of 0.25 to 2.00.

5. A nonaqueous electrolyte battery comprising:
a positive electrode;
a negative electrode; and
a nonaqueous electrolyte,
wherein the nonaqueous electrolyte contains an electrolyte salt, at least one of dimethyl carbonate and ethyl methyl carbonate, a chain carbonate ester represented by formula (I), and a polysiloxane compound represented by formula (II) 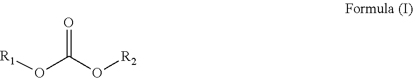
(R₁ represents CₙH₂ₙ₊₁, and n represents an integer of 13 to 20; and R₂ represents CₙH₂ₙ₊₁, and n represents an integer of 1 to 20), 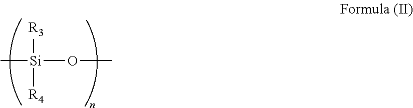
(R₃ and R₄ each represent hydrogen (H), an alkyl group having 1 to 50 carbon atoms, or a phenyl group).

6. The nonaqueous electrolyte battery according to claim 5,
wherein the content of the chain carbonate ester is in a range of 0.05 to 1.0 percent by mass.

7. The nonaqueous electrolyte battery according to claim 5,
wherein the content of the polysiloxane compound is in a range of 0.05 to 1.0 percent by mass.

8. The nonaqueous electrolyte battery according to claim 5,
wherein the mass ratio of the content of the chain carbonate ester to the content of the polysiloxane compound is in a range of 0.25 to 2.00.

9. The nonaqueous electrolyte battery according to claim 5,
further comprising a laminate film functioning as an exterior member.

10. A nonaqueous electrolyte battery comprising:
a positive electrode;
a negative electrode; and
a nonaqueous electrolyte which contains an electrolyte salt and at least one of dimethyl carbonate and ethyl methyl carbonate,
wherein the positive electrode is provided at least partially on a surface thereof with a coating film derived from a chain carbonate ester represented by formula (I) and a coating film derived from a polysiloxane compound represented by formula (II) 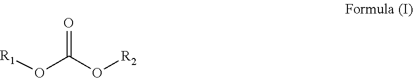
(R₁ represents CₙH₂ₙ₊₁, and n represents an integer of 13 to 20; and R₂ represents CₙH₂ₙ₊₁, and n represents an integer of 1 to 20), 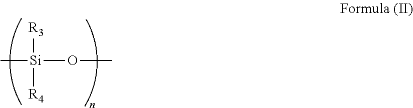
(R₃ and R₄ each represent hydrogen (H), an alkyl group having 1 to 50 carbon atoms, or a phenyl group).

11. The nonaqueous electrolyte battery according to claim 10,
further comprising a laminate film functioning as an exterior member.
